(19) United States
(12) Patent Application Publication
(10) Pub. No.: US 2015/0342159 A1
(43) Pub. Date: Dec. 3, 2015

(54) MODULAR FISH TANK AND DISPLAY

(71) Applicant: Ray Shaw, Rye, CO (US)

(72) Inventor: Ray Shaw, Rye, CO (US)

(21) Appl. No.: 14/685,075

(22) Filed: Apr. 13, 2015

Related U.S. Application Data
(60) Provisional application No. 61/978,343, filed on Apr. 11, 2014.

(51) Int. Cl. A01K 63/00; A01K 63/06

(52) U.S. Cl. CPC A01K 63/003; A01K 63/06; A01K 63/006

(57) ABSTRACT

A modular fish tank includes a chamber including a front section and a back section. The front section of the chamber includes a spherical bulb extended out from the chamber and is configured to magnify objects in the back section of the chamber when the chamber is filled with water. In an arrangement of two or more modular fish tanks, at least one of the modular fish tank in the arrangement is in a contact position next to another one of the modular fish tank in the arrangement. A viewing station for the modular fish tank includes one or more levels, and the levels each includes one or more modular fish tanks.

### CROSS REFERENCE TO RELATED APPLICATION

The present application claims the benefits of and priority, under 35 U.S.C. §119(e), to U.S. Provisional Application Ser. No. 61/978,343, filed Apr. 11, 2014; the above-identified application being fully incorporated herein by reference.

### BACKGROUND OF THE INVENTION

### Field of the Invention

The present invention generally relates to a modular fish tank and more particularly to displaying fish through a modular fish tank providing magnification.

### SUMMARY OF THE INVENTION

The present disclosure can provide a number of advantages depending on the particular aspect, embodiment, and/or configuration. These and other advantages will be apparent from the disclosure. Additional features and advantages may be learned by the practice of the invention.

To achieve these and other advantages, as embodied and broadly described, a modular fish tank includes a chamber; the chamber includes a front section and a back section; the front section is configured to magnify objects in the back section when the chamber is filled with water. In a configuration, the front section includes a spherical bulb extended out from the chamber. In a configuration, the back section includes one or more dividers separating the back section into one or more units. In a configuration, the back section includes a narrowing body. In a configuration, the chamber includes transparent or translucent material. In a configuration, the chamber includes plastic, glass, or acrylic material. In a configuration, the modular fish tank further includes a lid. In a configuration, the lid includes a hole. In a configuration, the lid includes a light. In a configuration, the light includes an LED light. In a configuration, the modular fish tank is configured to be arranged with one or more other modular fish tanks to form part of a circle. In a configuration, the modular fish tank includes a 45 degrees slice of the circle. In a configuration, the chamber is configured to show one or more fish, plant, rocks, and corral. In a configuration, the light includes one or more colors.

In another embodiment, a viewing station includes one or more levels, the levels each includes one or more modular fish tanks; the modular fish tank each includes a chamber; the chamber includes a front section and a back section; the front section is configured to magnify objects in the back section when the chamber is filled with water; the modular fish tanks of each level are arranged to form at least part of a circle. In a configuration, the viewing station further includes one or more levels, each level comprises one or more lights. In a configuration, the viewing station further includes one or more levels, each level includes one or more cups of fish. In a configuration, at least one level comprises an arrangement of two or more modular fish tanks; at least one of the modular fish tanks in the arrangement is in a contact position next to another one of the modular fish tanks in the arrangement.

In yet another embodiment, an arrangement of modular fish tank includes an arrangement of two or more modular fish tanks; at least one of the modular fish tanks in the arrangement is in a contact position next to another one of the modular fish tanks in the arrangement; the modular fish tank each includes a chamber; the chamber includes a front section and a back section; the front section is configured to magnify objects in the back section when the chamber is filled with water.

It is to be understood that both the foregoing general description and the following detailed description are exemplary and explanatory and are intended to provide further explanation of the invention as claimed.

The present disclosure can provide a number of advantages depending on the particular aspect, embodiment, and/or configuration. These and other advantages will be apparent from the disclosure.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

It shall be understood that the term “means,” as used herein, shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible, utilizing, alone or in combination, one or more of the features set forth above or described in detail below.

### BRIEF DESCRIPTION OF THE FIGURES

The accompanying figures, which are included to provide a further understanding of the invention, are incorporated in and constitute a part of this specification, illustrate embodiments of the invention and together with the description serve to explain the principles of the invention.

FIGS. 1A-C illustrate exemplary views of a modular fish tank according to an embodiment;

FIG. 2 illustrates an exemplary view of modular fish tanks arrangement according to an embodiment;

FIGS. 3A-3C illustrate exemplary views of viewing stations according to embodiments;

FIGS. 4A-4C illustrate exemplary views of modular fish tanks arrangements according to embodiments; and

FIG. 5 shows an exemplary view of a modular fish tank according to an embodiment.

### DETAILED DESCRIPTION OF THE PREFERRED EMBODIMENTS

Reference will now be made in additional detail to an embodiment of the present invention, examples of which are illustrated in the accompanying figures.

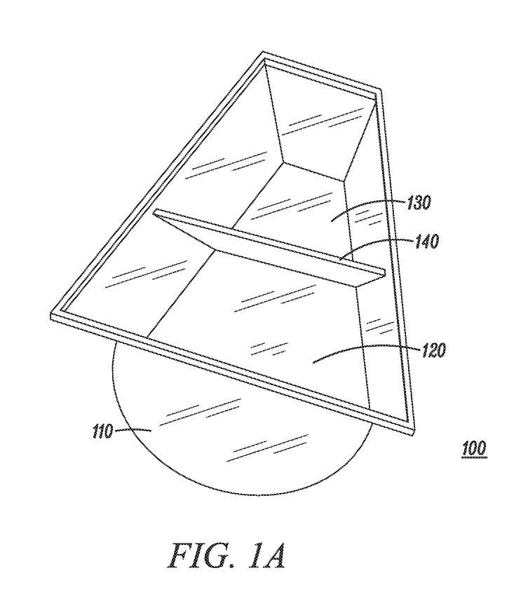

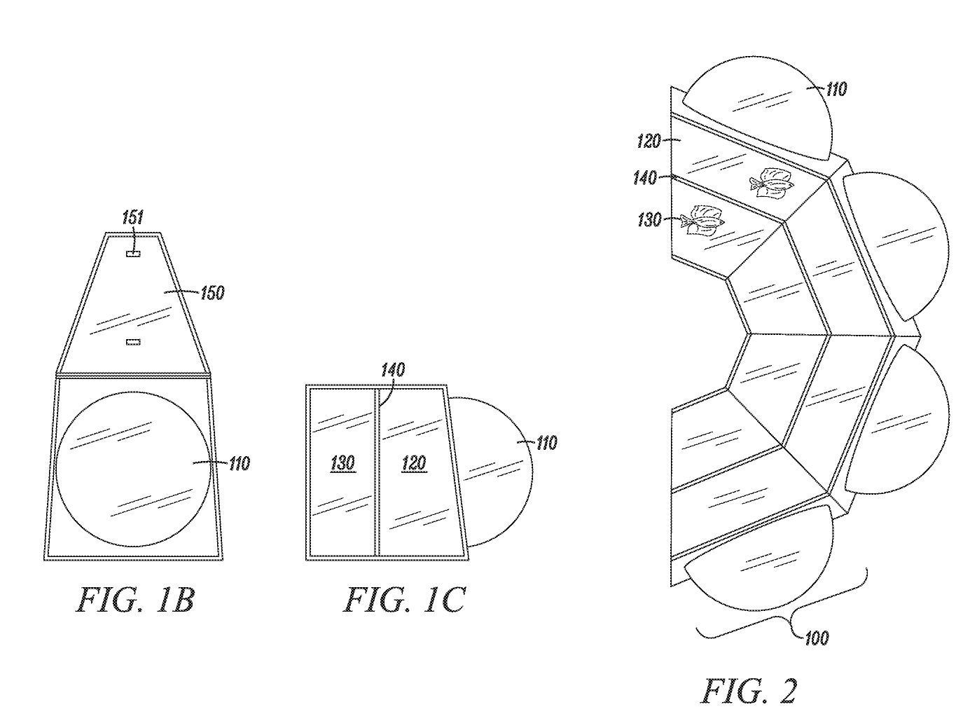

FIGS. 1A-C illustrate exemplary views of a modular fish tank according to an embodiment. FIG. 1A illustrates an exemplary top view of a modular fish tank. FIG. 1B illustrates a pattern view including a front and top of a modular fish tank. FIG. 1C illustrates a side view of a modular fish tank.

In an embodiment, the modular fish tank 100 includes an enclosed, water-proof space. The front of the modular fish tank 100 includes a bulb 110. The main chamber of the modular fish tank 100 is positioned to the back of the bulb 110 and is enclosed on three sides by the side and back walls. The main chamber may be divided into two sections, the front chamber 120 and the back chamber 130. The front chamber 120 and the back chamber 130 may be divided by the divider 140. The top of the modular fish tank 100 may be fitted with the lid 150.

In an embodiment, the interior of the fish tank 100, including the bulb 110 and the chambers 120 and 130 may be filled with water for placing a fish, e.g., Betta fish, gold fish, guppies, tropical fish, or other viewing or pet fish, or other aquarium organisms, e.g., turtles, seahorses, starfish, jellyfish, or viewing vivarium, e.g., plants, rock, and corral, for viewing or other purposes.

In an embodiment, the fish tank 100 is made of plastic, acrylic, glass, or other transparent, translucent, or other materials that may allow at least some visible light to pass through, i.e., light in the visible spectrum, and the light may be diffused or scattered to various colors, polarization, and other properties. In an embodiment, the material may have color filter to the light or may work with other materials, i.e., polarization film, to visibly change the light that passes through.

In an embodiment, the bulb 110 is dimensioned such that the bulb 110, using the index of refraction of water, may magnify objects in the chambers of the fish tank 100. For example, the bulb 110 may take the shape of the half sphere facing outward from the fish tank 100. As such, the bulb 110 has an increased spherical surface area that allows light from the chambers to diverge through the increased spherical surface area, especially when the object is in the chambers 120 and 130 where the planer surface slices are flat compared with the spherical surface of the bulb 110, thereby achieving a magnification effect.

In an embodiment, various background pictures or other display, e.g., backdrop photos of the sea or other pictures, may be used on the interior or exterior of the fish tank 100. The bulb 110 may also magnify and display the contents of such pictures in conjunction with the objects inside the fish tank 100.

In a preferred embodiment, the bulb 110 is a half sphere with a diameter of approximately 6½″. The front and sides of the fish tank 100 are approximately 7″ at the bottom and 6″ at the top. The back of the fish tank 100 is approximately 3″, and the height is 7½″. The length of the front chamber 120 is approximately 3″ and the back chamber 130 is approximately 4″ to give the front chamber 120 and the back chamber 130 approximately the same volume. For Betta fish, this is a preferred size as Betta fishes like to live in small places. Further, this size enables the fish tank 100 to be easily cleaned and moved around. The dimension above may be filled with less than 1 gallon of water; therefore, it facilitates the fish tank 100 to be placed on most desks, bookshelves, end tables, or other furniture and acts as an artistic conversation piece. In another embodiment, fish tank 100 may be of various shapes and dimensions as needed for various purposes. For example, the fish tank 100 may be larger or smaller depending on the size and volume of the tank as needed.

In an embodiment, the divider 140 divides the first chamber 120 from the second chamber 130. This allows one or more fish to be placed in each respective chamber. This is useful to separate fighting fishes from each other. Further, the fishes may congregate at the divider 140, where the magnification may be optimal, to display to each other, facilitating outside observation of the fishes in the fish tank 100. In another embodiment, fish tank 100 may be made of additional chambers. For example, the fish tank 100 may have only one chamber or may have multiple chambers, and the multiple chambers may be divided by various dividers in various orientations. Divider 140 is shown to orientate vertically to divide fish tank 100 into the front chamber 120 and the back chamber 130. Other dividers may be used vertically to further divide the fish tank 100 into additional vertical chambers or horizontally to divide the fish tank 100 into horizontal chambers.

In an embodiment, the edges of fish tank 100 are rounded, e.g., the edges that various pieces (front, sides, and back) of fish tank 100 are rounded. In some applications, this helps with the display of the fish tank 100 as the incident light from the edges do not converge or diverge to one point but may gradually spread to the magnification bulb 110, so as to lessen the distraction of the edges and the corners of fish tank 100 when magnified.

A method of making the fish tank 100 is disclosed as follows. The fish tank 100 may be made using various molding techniques for plastic, glass, or other materials, such as injection molding, blow molding, and other methods as known now or may be later derived. In an embodiment, the fish tank 100 may be molded as one flat piece, with the front including the bulb 100, the sides, and the back attached to the bottom portion of fish tank 100. The front, sides, and the back may be folded upward and glued (or using other attachment methods) at the edges. In another embodiment, the fish tank 100 may be made with other assembly techniques, e.g., pre-fabrication of the various sides of the fish tank 100 as panels and joining the sides using glue or other attachment components.

The lid 150 is used to close the top of fish tank 100 after the fish tank 100 is filled with water. In an embodiment, the lid 150 may include mechanisms for closing and securing the lid 150 to the top of the fish tank 100. For example, the lid 150 may include alignment strips 151 and other means for securing the lid 150, e.g., a hinge, a lock, and other means as known now or may be later derived in the art. Lid 150 may include one or more air holes for allowing air into the interior of the fish tank 100 when the lid is closed, supplying air for the fish and other life placed in the fish tank 100.

In an embodiment, the lid 150 may include an integrated light source, e.g., LED light of various color. The light may be used as the incident light for the display, when the light enters water of the fish tank 100, is reflected by the fish and other contents of the fish tank 100, and is magnified by the bulb 110. In another embodiment, the light source may be placed at various locations within, e.g., the back, bottom, sides, or front of fish tank 100, or outside of fish tank 100 to generate various effect with the incident light. In a further embodiment, additional lights in various locations may also be used as other light sources.

In an embodiment, an angle mirror may be place parallel to the bottom of fish tank 100 and facing the bulb 110. This is useful, for example, if a user would like to place the fish tank 100 at a low position, e.g., underneath a desktop, and have the image of the bulb 110 reflect out by the mirror through the desk top. In other embodiments, other mirror placements may be used for various positions and effects.

FIG. 2 illustrates an exemplary view of modular fish tanks arrangement according to an embodiment.

In an embodiment, multiple fish tanks 100 may be positioned and arranged in various configurations according to user display preference.

Referring to FIG. 2, four fish tanks 100 are juxtaposed side-by-side and aligned in a similar direction (the front of a fish tank is aligned with the front of the adjacent fish tank). In such a juxtaposition and alignment, the fish tanks 100 (with each fish tank 100 having the dimensions as discussed above) are arranged in a half-circle arrangement. As such, each fish tank 100 make up a 45 degrees slice of the half-circle (the arrangement having 180 degrees total).

In other embodiments, other arrangements may be made by positioning other numbers of multiple module fish tanks 100. For example, eight fish tanks 100 may be positioned in a 360 degrees circle. In another example, two fish tanks 100 may be arranged next to each other to form a 90 degrees configuration; this configuration may be fitted to be placed at the corner of a room. The configuration of the four fish tanks arrangement (as shown in FIG. 2) may also be fitted to be placed at a straight section of a wall.

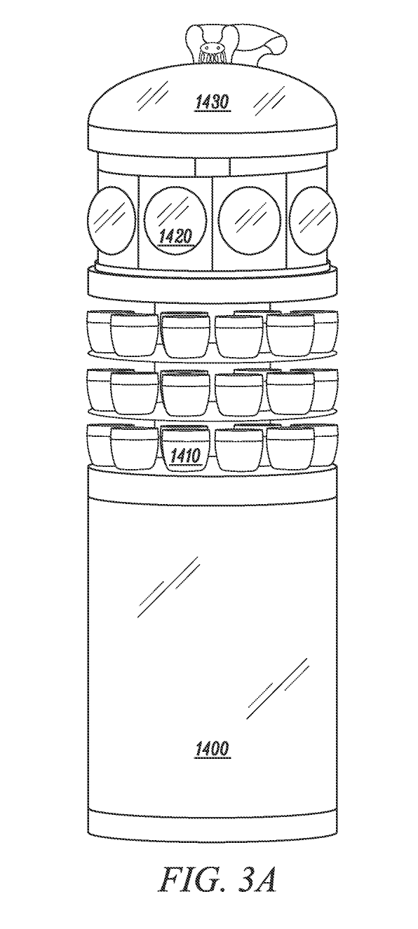

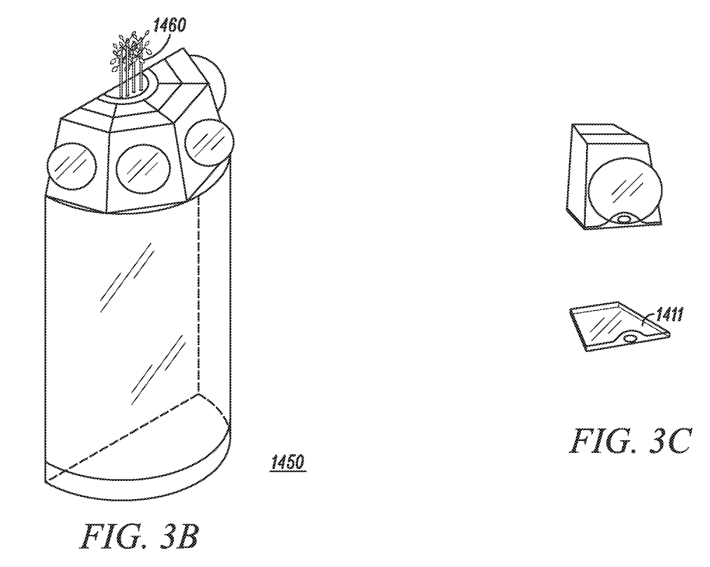

FIGS. 3A-3C illustrate exemplary views of viewing stations according to embodiments.

In an embodiment, the fish tanks 100 may be displayed on a viewing station. The viewing station may include one or more fish tanks 100 with fishes arranged in various arrangements and also cups of fishes for displaying the fishes in an easily accessible and attention getting manner. For example, the viewing station may be used in a store that sells Betta fishes or other types of fishes or objects for sale.

Referring to FIG. 3A, the viewing station 1400 includes levels 1410 for placing Betta cups containing Betta fishes (or other contents) and one or more levels 1420 for placing the modular fish tanks. The light 1430 may be placed at a level on top of the fish tank's level 1420 for directing incident light from the top of the fish tanks. The light 1430 may also be placed at other levels, e.g., below the fish tank's level or in between the fish tank's levels, for other arrangement of the incident light.

In an embodiment, the viewing station 1400 may be decorated with various ornaments for function and aesthetics. For example, arts, advertisements, and other decorations may be placed on the base of the viewing station 1400. A sculpture or other piece may be placed on the top of the viewing station 1400.

In an embodiment, the viewing station 1400 may be modular in that various levels of the viewing station 1400 may be taken off or combined separately and may be used with other existing structures. For example, the top portion of the viewing station 1400 consisting of the fish tank levels 1420 and the light 1430 may be used as a partial viewing station 1400 and placed on top of a separate structure. Referring to FIG. 12, a number of various configurations for viewing station 1400 is shown, e.g., alternating levels of fish tanks and fish cups and other arrangements.

Referring to FIG. 3B, in an embodiment, the half viewing station 1450 is a half wall unit that takes the shape of a half cylinder. Four fish tanks may be arranged on top of the half viewing station 1450 comprising 180 degrees. A space 1460 in the middle is formed by the four fish tanks arranged in the half circle. In an embodiment, plants, e.g., bamboo, or other ornaments may be placed in the space 1460.

Referring to FIG. 3C, in an embodiment, the fish tanks may be placed on one or more light trays 1411. The light tray 1411 includes a light source, e.g., LED light source, and provides incident light from the bottom of the fish tanks when the fish tanks is placed on the light tray 1411. The light tray 1411 may be used in conjunction with the light 1430 or other light sources with incident light from other directions.

In general embodiment, the viewing station may be a free standing unit that includes one or more modular fish tanks 100 and one or more lights. In an embodiment, the fish tanks 100 may be arranged as a circle on the viewing station. The viewing station may have multiple levels of fish tanks 100 arranged in a circle. The lights may be placed in between levels of the viewing station. Because of the circular configuration of the fish tanks 100, one may be able to walk in full circle around the viewing station. The lights may include flashing lights of various colors and patterns, thereby causing a kaleidoscope appearance when reflected off the magnifier of the fish tanks 100. When lit up, the viewing station may be very exciting and fun to watch.

In a preferred embodiment, the viewing station may have a diameter of approximately 24″ and a height of approximately 6′. As such, the viewing station takes up only 4 square feet of floor space. The viewing station may be placed as a display in a pet store, offices, waiting rooms, homes, and businesses.

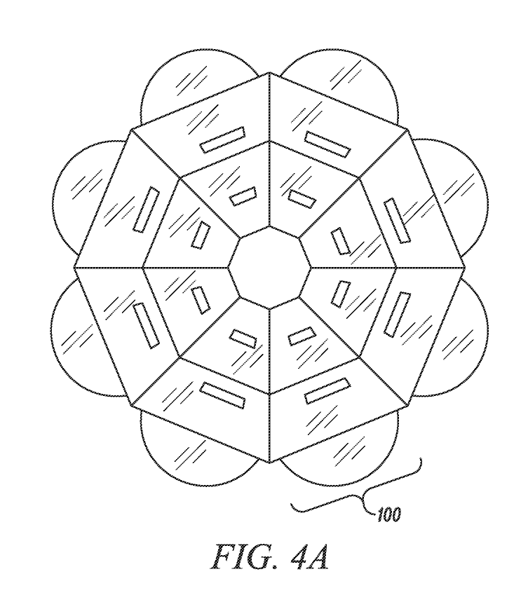

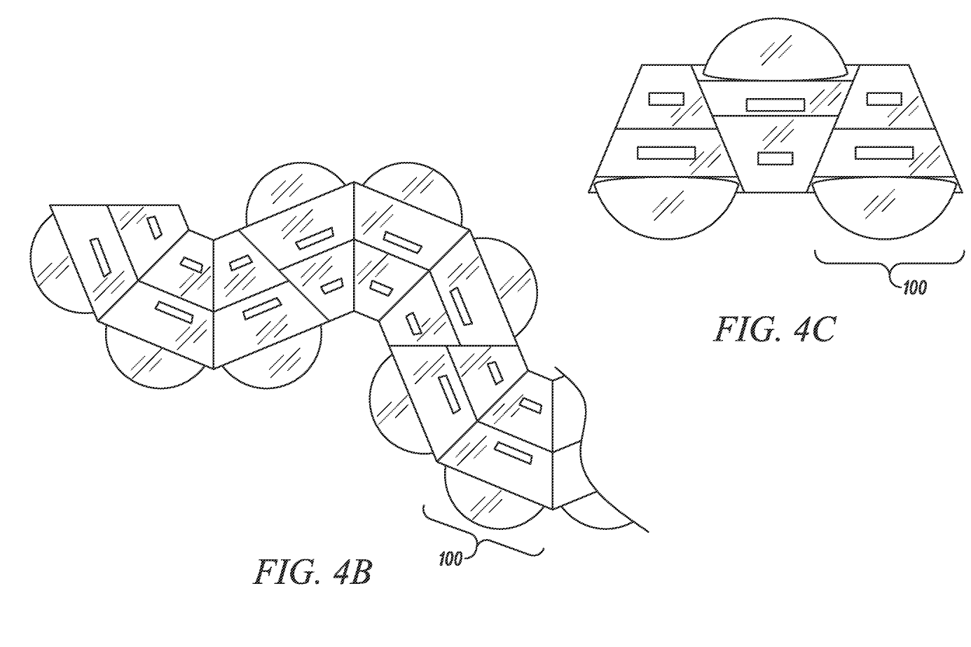

FIGS. 4A-4C illustrate exemplary views of modular fish tanks arrangements according to embodiments.

Referring to FIG. 4A, eight fish tanks 100 are juxtaposed side-by-side and aligned in a similar direction. The resulting arrangement is a circle configuration (360 degrees).

Referring to FIG. 4B, groups of three fish tanks 100 are juxtaposed side-by-side and aligned in a similar direction while each group (of the three fish tanks) are aligned in an opposite direction with an adjacent group (e.g., the front of an end fish tank of the group is aligned with the back of the adjacent end fish tank of the adjacent group and the back of the end fish tank of the group is aligned with the front of the adjacent end fish tank of the adjacent group). As such, each group of the three fish tanks 100 form a 135 degrees “corner” configuration attached to another group of three fish tanks 100 in an opposite 135 degrees “corner” configuration. The resulting arrangement of multiple groups of the three fish tanks 100 is a snake like pattern with 135 degrees “corner” curves.

Referring to FIG. 4C, each fish tank 100 is juxtaposed side-by-side and aligned in an opposite direction with an adjacent fish tank 100. The resulting arrangement is a straight line of opposite aligned fish tanks 100.

FIGS. 4A-4C illustrate merely exemplary arrangements of two or more fish tanks 100. It is noted that other arrangements and configurations are possible as known now or may be later derived through the practice of embodiments of the invention.

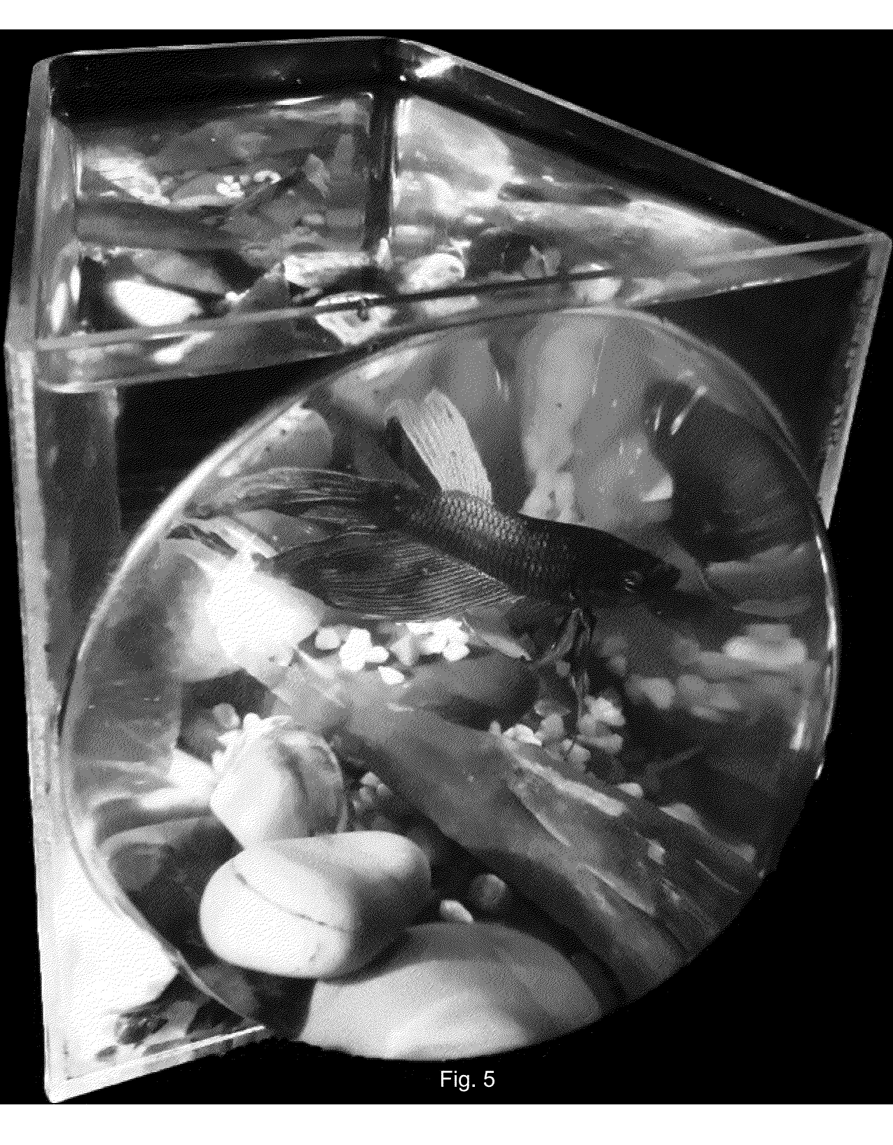

FIG. 5 shows an exemplary view of a modular fish tank according to an embodiment.

Referring to FIG. 5, the magnification effect of the fish tank 100 is shown in a photograph of an exemplary fish tank. In the fish tank, the Betta fish in the tank is magnified when viewed in the bulb portion of the fish tank. Also magnified are rocks, plants, other ambient features in the fish tank for aesthetically pleasing viewing of the magnified Betta fish.

In further embodiments, various colors and kaleidoscope effects are resulting from a combination of fish tank arrangements, backdrop photos, content (e.g., fish, plants, or other objects) positions within the fish tank, incident light positions (e.g., light at a position of the fish tank, light from the camera, and other positions), and other variables (e.g., lighting condition of the room and angle of camera and/or view).

A number of variations and modifications of the disclosure can be used. It would be possible to provide for some features of the disclosure without providing others.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. For example, in the foregoing description various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this description, with each claim standing on its own as a separate preferred embodiment of the disclosure.

Moreover, though the description has included a description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A modular fish tank, comprising:
a chamber, wherein the chamber comprises a front section and a back section, wherein the front section is configured to magnify objects in the back section when the chamber is filled with water.

2. The modular fish tank of claim 1, wherein the front section comprises a spherical bulb extended out from the chamber.

3. The modular fish tank of claim 1, wherein the back section comprises one or more dividers separating the back section into one or more units.

4. The modular fish tank of claim 1, wherein the back section comprises a narrowing body.

5. The modular fish tank of claim 1, wherein the chamber comprises transparent or translucent material.

6. The modular fish tank of claim 1, wherein the chamber comprises plastic, glass, or acrylic material.

7. The modular fish tank of claim 1, further comprising a lid.

8. The modular fish tank of claim 7, wherein the lid comprises a hole.

9. The modular fish tank of claim 7, wherein the lid comprises a light.

10. The modular fish tank of claim 9, wherein the light comprises an LED light.

11. The modular fish tank of claim 1, wherein the modular fish tank is configured to be arranged with one or more other modular fish tanks to form a part of a circle.

12. The modular fish tank of claim 11, wherein the modular fish tank comprises a 45 degrees slice of the circle.

13. The modular fish tank of claim 1, wherein the chamber is configured to show one or more fish, plant, rocks, and corral.

14. The modular fish tank of claim 9, wherein the light comprises one or more colors.

15. A viewing station, comprising:
one or more levels, the levels each comprises one or more modular fish tanks, wherein the modular fish tanks each comprises a chamber, wherein the chamber comprises a front section and a back section, wherein the front section is configured to magnify objects in the back section when the chamber is filled with water, and wherein the modular fish tanks of each level are arranged to form at least part of a circle.

16. The viewing station of claim 15, further comprising one or more levels, each level comprises one or more light.

17. The viewing station of claim 15, further comprising one or more levels, each level comprises one or more cups of fish.

18. The viewing station of claim 15, wherein at least one level comprises an arrangement of two or more modular fish tanks, and wherein at least one of the modular fish tanks in the arrangement is in a contact position next to another one of the modular fish tanks in the arrangement.

19. An arrangement of modular fish tanks, comprising an arrangement of two or more modular fish tanks, wherein at least one of the modular fish tanks in the arrangement is in a contact position next to another one of the modular fish tanks in the arrangement, and wherein the modular fish tanks each comprises a chamber, wherein the chamber comprises a front section and a back section, and wherein the front section is configured to magnify objects in the back section when the chamber is filled with water.

20. The arrangement of modular fish tanks of claim 19, wherein the front section of the at least one modular fish tank contacts the front section of the another one modular fish tank and the back section of the at least one modular fish tank contacts the back section of the another one modular fish tank.
